(19) United States
(12) Patent Application Publication
(10) Pub. No.: US 2015/0006610 A1
(43) Pub. Date: Jan. 1, 2015

(54) VIRTUAL WEB REAL-TIME COMMUNICATIONS (WEBRTC) GATEWAYS, AND RELATED METHODS, SYSTEMS, AND COMPUTER-READABLE MEDIA

(71) Applicant: Avaya Inc., Basking Ridge, NJ (US)

(72) Inventors: Alan B. Johnston, St. Louis, MO (US); John H. Yoakum, Cary, NC (US)

(21) Appl. No.: 13/931,967

(22) Filed: Jun. 30, 2013

(51) Int. Cl. H04L 29/08

(52) U.S. Cl. CPC H04L 67/02
USPC 709/202

(57) ABSTRACT

Virtual Web Real-Time Communications (WebRTC) gateways, and related methods, systems, and computer-readable media are disclosed herein. In one embodiment, a method for providing a virtual WebRTC gateway comprises instantiating a virtual WebRTC agent corresponding to a WebRTC client, and instantiating a virtual non-WebRTC agent corresponding to a non-WebRTC client. The method further comprises establishing a WebRTC interactive flow between the virtual WebRTC agent and the WebRTC client, and establishing a non-WebRTC interactive flow between the virtual non-WebRTC agent and the non-WebRTC client. The method also comprises directing a content of the WebRTC interactive flow to the non-WebRTC interactive flow, and a content of the non-WebRTC interactive flow to the WebRTC interactive flow, via the virtual WebRTC agent and the virtual non-WebRTC agent. In this manner, the virtual WebRTC gateway may provide interoperability between otherwise-incompatible WebRTC clients and non-WebRTC clients.

### BACKGROUND

1. Field of the Disclosure

The technology of the disclosure relates generally to Web Real-Time Communications (WebRTC) interactive sessions.

2. Technical Background

Web Real-Time Communications (WebRTC) represents an ongoing effort to develop industry standards for integrating real-time communications functionality into web clients, such as web browsers, to enable direct interaction with other web clients. This real-time communications functionality is accessible by web developers via standard markup tags, such as those provided by version 5 of the Hypertext Markup Language (HTML5), and client-side scripting Application Programming Interfaces (APIs), such as JavaScript APIs. More information regarding WebRTC may be found in “WebRTC: APIs and RTCWEB Protocols of the HTML5 Real-Time Web,” by Alan B. Johnston and Daniel C. Burnett (2012 Digital Codex LLC), which is incorporated herein in its entirety by reference.

WebRTC provides built-in capabilities for establishing real-time video, audio, and/or data streams in both point-to-point interactive sessions and multi-party interactive sessions. The WebRTC standards are currently under joint development by the World Wide Web Consortium (W3C) and the Internet Engineering Task Force (IETF). Information on the current state of WebRTC standards can be found at, e.g., http://www.w3c.org and http://www/ietf.org.

Existing protocols for providing interactive flows, such as Session Initiation Protocol (SIP), H.323, and Jingle, are not compatible with WebRTC due to new features and media extensions provided by WebRTC. As a result, retrofitting gateway applications that employ these existing protocols to add WebRTC capabilities would involve non-trivial development efforts. Moreover, the varying levels of WebRTC support that are currently provided by different WebRTC clients may present further compatibility and support issues for gateway applications.

### SUMMARY OF THE DETAILED DESCRIPTION

Embodiments disclosed in the detailed description provide virtual Web Real-Time Communications (WebRTC) gateways. Related methods, systems, and computer-readable media are also disclosed. In some embodiments, an interactive flow server, through which a WebRTC client and a non-WebRTC client seek to establish an interactive session, instantiates a virtual WebRTC agent and a virtual non-WebRTC agent. The interactive flow server may cause the WebRTC client to establish a WebRTC interactive flow with the virtual WebRTC agent, and may cause the non-WebRTC client to establish a non-WebRTC interactive flow with the virtual non-WebRTC agent. The interactive flow server may then connect the virtual WebRTC agent and the virtual non-WebRTC agent “back-to-back” by directing output from the virtual WebRTC agent as input into the virtual non-WebRTC agent, and vice versa. In this manner, the interactive flow server may provide a virtual WebRTC gateway between the WebRTC client and the non-WebRTC client, while also providing additional media processing and handling functionality. As non-limiting examples, the media processing and handling functionality may include recording and/or monitoring of the WebRTC and/or non-WebRTC interactive flows, and/or extracting content from or injecting content into the WebRTC and/or non-WebRTC interactive flows.

In this regard, in one embodiment, a method for providing a virtual WebRTC gateway is provided. The method comprises instantiating, by a virtual WebRTC gateway executing on a computing device, a virtual WebRTC agent corresponding to a WebRTC client. The method further comprises instantiating a virtual non-WebRTC agent corresponding to a non-WebRTC client. The method also comprises establishing a WebRTC interactive flow between the virtual WebRTC agent and the WebRTC client. The method additionally comprises establishing a non-WebRTC interactive flow between the virtual non-WebRTC agent and the non-WebRTC client. The method further comprises directing a content of the WebRTC interactive flow to the non-WebRTC interactive flow, and a content of the non-WebRTC interactive flow to the WebRTC interactive flow, via the virtual WebRTC agent and the virtual non-WebRTC agent.

In another embodiment, a system for providing a virtual WebRTC gateway is provided. The system comprises at least one communications interface, and an interactive flow server associated with the at least one communications interface. The interactive flow server comprises a virtual WebRTC gateway configured to instantiate a virtual WebRTC agent corresponding to a WebRTC client, and instantiate a virtual non-WebRTC agent corresponding to a non-WebRTC client. The virtual WebRTC gateway is further configured to establish a WebRTC interactive flow between the virtual WebRTC agent and the WebRTC client. The virtual WebRTC gateway is also configured to establish a non-WebRTC interactive flow between the virtual non-WebRTC agent and the non-WebRTC client. The virtual WebRTC gateway is additionally configured to direct a content of the WebRTC interactive flow to the non-WebRTC interactive flow, and a content of the non-WebRTC interactive flow to the WebRTC interactive flow, via the virtual WebRTC agent and the virtual non-WebRTC agent.

In another embodiment, a non-transitory computer-readable medium is provided. The non-transitory computer-readable medium has stored thereon computer-executable instructions to cause a processor to implement a method comprising instantiating a virtual WebRTC agent corresponding to a WebRTC client. The method implemented by the computer-executable instructions further comprises instantiating a virtual non-WebRTC agent corresponding to a non-WebRTC client. The method implemented by the computer-executable instructions also comprises establishing a WebRTC interactive flow between the virtual WebRTC agent and the WebRTC client. The method implemented by the computer-executable instructions additionally comprises establishing a non-WebRTC interactive flow between the virtual non-WebRTC agent and the non-WebRTC client. The method implemented by the computer-executable instructions further comprises directing a content of the WebRTC interactive flow to the non-WebRTC interactive flow, and a content of the non-WebRTC interactive flow to the WebRTC interactive flow, via the virtual WebRTC agent and the virtual non-WebRTC agent.

### BRIEF DESCRIPTION OF THE FIGURES

The accompanying drawing figures incorporated in and forming a part of this specification illustrate several aspects of the disclosure, and together with the description serve to explain the principles of the disclosure.

FIG. 1 is a conceptual diagram illustrating an interactive session between a Web Real-Time Communications (WebRTC) client and a non-WebRTC client via an interactive flow server including a virtual WebRTC gateway;

FIG. 2 is a flowchart illustrating exemplary operations of the virtual WebRTC gateway of FIG. 1 for enabling interoperability between a WebRTC client and a non-WebRTC client;

FIG. 3 is a diagram illustrating exemplary communications flows for an outbound interaction request from a WebRTC client to a non-WebRTC client within an exemplary system including the virtual WebRTC gateway of FIG. 1;

FIG. 4 is a diagram illustrating exemplary communications flows for an inbound interaction request from a non-WebRTC client to a WebRTC client within an exemplary system including the virtual WebRTC gateway of FIG. 1;

FIGS. 5A and 5B are flowcharts illustrating more detailed exemplary operations for providing a virtual WebRTC gateway enabling outbound and/or inbound interaction requests from a WebRTC client to a non-WebRTC client, and additional media processing and handling functionality; and

FIG. 6 is a block diagram of an exemplary processor-based system that may include the virtual WebRTC gateway of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description provide virtual Web Real-Time Communications (WebRTC) gateways. Related methods, systems, and computer-readable media are also disclosed. In some embodiments, an interactive flow server, through which a WebRTC client and a non-WebRTC client seek to establish an interactive session, instantiates a virtual WebRTC agent and a virtual non-WebRTC agent. The interactive flow server may cause the WebRTC client to establish a WebRTC interactive flow with the virtual WebRTC agent, and may cause the non-WebRTC client to establish a non-WebRTC interactive flow with the virtual non-WebRTC agent. The interactive flow server may then connect the virtual WebRTC agent and the virtual non-WebRTC agent “back-to-back” by directing output from the virtual WebRTC agent as input into the virtual non-WebRTC agent, and vice versa. In this manner, the interactive flow server may provide a virtual WebRTC gateway between the WebRTC client and the non-WebRTC client, while also providing additional media processing and handling functionality. As non-limiting examples, the media processing and handling functionality may include recording and/or monitoring of the WebRTC and/or non-WebRTC interactive flows, and/or extracting content from or injecting content into the WebRTC and/or non-WebRTC interactive flows.

In this regard, in one embodiment, a method for providing a virtual WebRTC gateway is provided. The method comprises instantiating, by a virtual WebRTC gateway executing on a computing device, a virtual WebRTC agent corresponding to a WebRTC client. The method further comprises instantiating a virtual non-WebRTC agent corresponding to a non-WebRTC client. The method also comprises establishing a WebRTC interactive flow between the virtual WebRTC agent and the WebRTC client. The method additionally comprises establishing a non-WebRTC interactive flow between the virtual non-WebRTC agent and the non-WebRTC client. The method further comprises directing a content of the WebRTC interactive flow to the non-WebRTC interactive flow, and a content of the non-WebRTC interactive flow to the WebRTC interactive flow, via the virtual WebRTC agent and the virtual non-WebRTC agent.

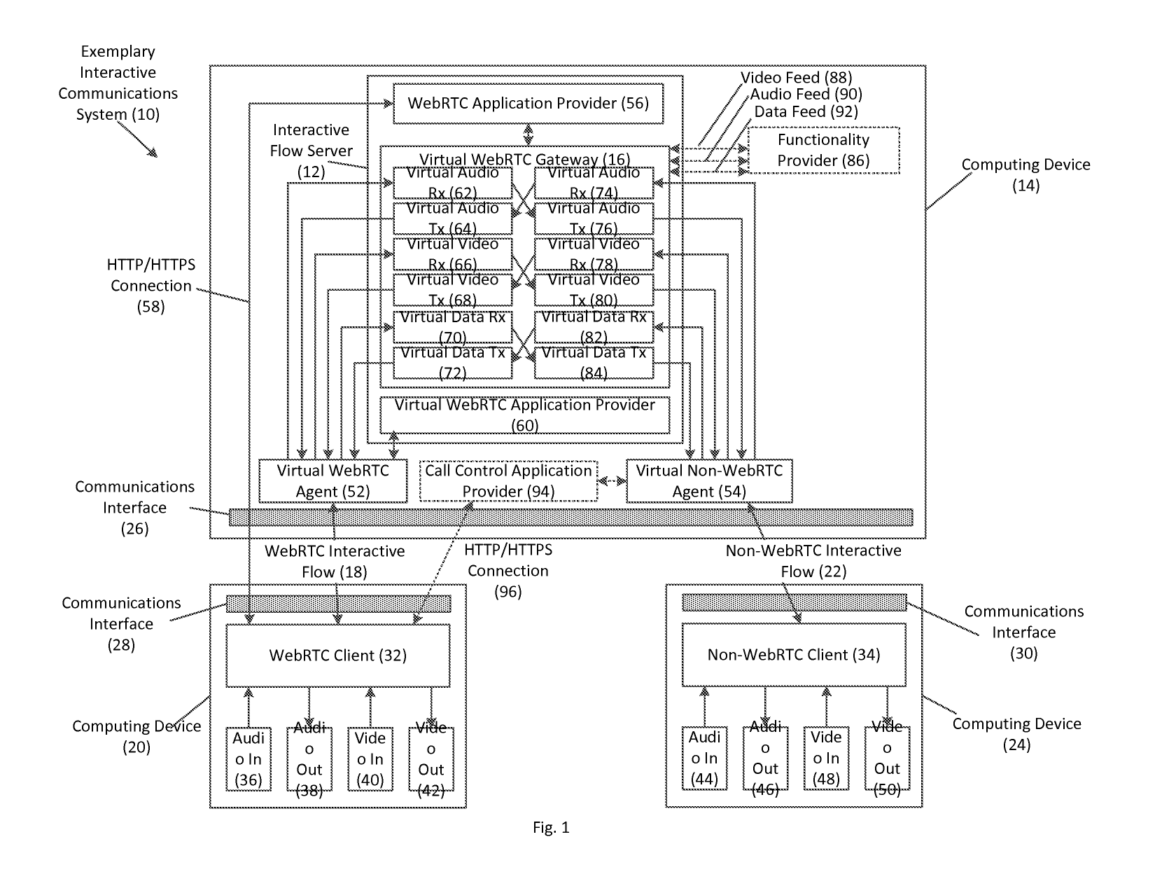

FIG. 1 illustrates an exemplary interactive communications system 10 providing virtual WebRTC gateways as disclosed herein. In particular, the exemplary interactive communications system 10 provides an interactive flow server 12 that executes on a computing device 14, and that includes a virtual WebRTC gateway 16. The virtual WebRTC gateway 16 handles instantiation of virtual WebRTC agents and virtual non-WebRTC agents, and coordinates establishing and directing of content of interactive flows to provide interoperability between a WebRTC endpoint and a non-WebRTC endpoint. As used herein, a “virtual WebRTC agent” refers to an instance of a WebRTC-enabled browser or other client application that executes on the computing device 14 under the control of the virtual WebRTC gateway 16. A “virtual non-WebRTC agent” refers to an instance of a client application that executes on the computing device 14 under the control of the virtual WebRTC gateway 16, and that provides real-time communications capabilities according to a protocol other than WebRTC. As non-limiting examples, such non-WebRTC protocols may include Session Initiation Protocol (SIP), H.323, Jingle, or other protocols providing session-centric interactive flows. A “WebRTC interactive flow,” as disclosed herein, refers to an interactive media flow and/or an interactive data flow that passes between or among two or more endpoints according to WebRTC, while a “non-WebRTC interactive flow” refers to an interactive media flow and/or an interactive data flow according to a protocol other than WebRTC. As non-limiting examples, an interactive media flow constituting a WebRTC or non-WebRTC interactive flow may comprise a real-time audio stream and/or a real-time video stream, or other real-time media or data streams. Data and/or media comprising an interactive flow may be collectively referred to herein as “content.”

For purposes of illustration, a WebRTC interactive flow 18 in FIG. 1 is shown as passing between the computing device 14 and a computing device 20, and a non-WebRTC interactive flow 22 is shown as passing between the computing device 14 and a computing device 24. It is to be understood that the computing devices 14, 20, and 24 may all be located within a same public or private network, or may be located within separate, communicatively coupled public or private networks. Some embodiments of the interactive communications system 10 of FIG. 1 may provide that each of the computing devices 14, 20, and 24 may be any computing device having network communications capabilities, such as a smartphone, a tablet computer, a dedicated web appliance, a media server, a desktop or server computer, or a purpose-built communications device, as non-limiting examples. The computing devices 14, 20, and 24 include communications interfaces 26, 28, and 30, respectively, for connecting the computing devices 14, 20, and 24 to one or more public and/or private networks. In some embodiments, the elements of the computing devices 14, 20, and 24 may be distributed across more than one computing device 14, 20, 24.

The computing device 20 of FIG. 1 includes a WebRTC client 32. The WebRTC client 32 may be a WebRTC-enabled web browser application, a dedicated communications application, a mobile application, or an interface-less application, such as a daemon or service application, as non-limiting examples. The WebRTC client 32 implements the protocols, codecs, and Application Programming Interfaces (APIs) necessary to provide the WebRTC interactive flow 18 between the computing device 20 and the computing device 14. The computing device 24 of FIG. 1 includes a non-WebRTC client 34, which provides real-time communications capabilities based on a protocol other than WebRTC. The non-WebRTC client 34 may be a web browser application, a dedicated communications application, a mobile application, or an interface-less application, such as a daemon or service application, as non-limiting examples. As a non-limiting example, the non-WebRTC client 34 may be a SIP user agent client providing a SIP signaling stack and a Real-time Transport Protocol (RTP) media stack compatible with a SIP network or service. In some embodiments, non-limiting examples of other non-WebRTC clients 34 may be an H.323 client application or a Jingle client application. The non-WebRTC client 34 implements the protocols, codecs, and APIs necessary to provide the non-WebRTC interactive flow 22 between the computing device 24 and the computing device 14.

As seen in FIG. 1, the computing device 20 is communicatively coupled to an audio in device 36 (e.g., a microphone) for receiving audio input, and an audio out device 38 (for example, speakers or headphones) for generating audio output. The computing device 20 is further communicatively coupled to a video in device 40 (such as a camera, webcam, or other video source) for receiving video input, and a video out device 42 (e.g., a display) for displaying video output. Likewise, the computing device 24 is communicatively coupled to an audio in device 44, an audio out device 46, a video in device 48, and a video out device 50. The audio in devices 36 and 44, the audio out devices 38 and 46, the video in devices 40 and 48, and/or the video out devices 42 and 50 may be integrated into the respective computing devices 20 and 24, and/or they may be peripheral devices and/or virtual devices communicatively coupled to the respective computing devices 20 and 24. In some embodiments, the computing devices 20 and/or 24 may be communicatively coupled to more or fewer devices than illustrated in FIG. 1.

Because WebRTC and non-WebRTC protocols are fundamentally incompatible, the WebRTC client 32 and the non-WebRTC client 34 are unable to establish an interactive flow directly with one another via a peer connection. To enable interoperability between the WebRTC client 32 and the non-WebRTC client 34, the virtual WebRTC gateway 16 provides a virtual WebRTC agent 52 and a virtual non-WebRTC agent 54. In the example of FIG. 1, the WebRTC client 32 downloads a WebRTC web application (not shown) from a WebRTC application provider 56 of the interactive flow server 12 via a Hyper Text Transfer Protocol (HTTP)/Hyper Text Transfer Protocol Secure (HTTPS) connection 58. In some embodiments, the WebRTC web application may comprise an HTML5/JavaScript web application that provides a rich user interface using HTML5, and uses JavaScript to handle user input and to communicate with the WebRTC application provider 56. The virtual WebRTC gateway 16 then instantiates the virtual WebRTC agent 52 corresponding to the WebRTC client 32. In some embodiments, the virtual WebRTC gateway 16 may instantiate the virtual WebRTC agent 52 by launching an instance of a WebRTC client, such as a web browser, on the computing device 14. Some embodiments may provide that the virtual WebRTC agent 52 is executed within a virtual instance of an operating system.

After instantiation, the virtual WebRTC agent 52 is directed by the virtual WebRTC gateway 16 to download a virtual WebRTC application (not shown) from a virtual WebRTC application provider 60. Some embodiments may provide that the virtual WebRTC application provider 60 is communicatively coupled to the virtual WebRTC gateway 16. In some embodiments, the virtual WebRTC application provider 60 may be integrated into or otherwise constitute an element of the virtual WebRTC gateway 16 and/or the WebRTC application provider 56. The virtual WebRTC application includes specialized instructions for interfacing with the WebRTC APIs of the virtual WebRTC agent 52. The virtual WebRTC agent 52 may communicate via the virtual WebRTC application with the WebRTC client 32, and with the virtual WebRTC gateway 16.

The virtual WebRTC gateway 16 also instantiates the virtual non-WebRTC agent 54 corresponding to the non-WebRTC client 34. In some embodiments, the virtual WebRTC gateway 16 may instantiate the virtual non-WebRTC agent 54 by launching one or more instances of a non-WebRTC client, such as a SIP user agent client, an H.323 client, or a Jingle client, on the computing device 14. Some embodiments may provide that the virtual non-WebRTC agent 54 is executed within a virtual instance of an operating system.

The virtual WebRTC gateway 16 causes the virtual WebRTC agent 52 to establish the WebRTC interactive flow 18 with the WebRTC client 32, and also causes the virtual non-WebRTC agent 54 to establish the non-WebRTC interactive flow 22 with the non-WebRTC client 34. The virtual WebRTC gateway 16 then connects the virtual WebRTC agent 52 and the virtual non-WebRTC agent 54 “back-to-back” (i.e., the content output by the WebRTC interactive flow 18 of the virtual WebRTC agent 52 is directed as input into the non-WebRTC interactive flow 22 of the virtual non-WebRTC agent 54, and vice versa). To accomplish a “back-to-back” connection, the virtual WebRTC gateway 16 provides a virtual audio receiver (Rx) 62, a virtual audio transmitter (Tx) 64, a virtual video receiver 66, a virtual video transmitter 68, a virtual data receiver 70, and a virtual data transmitter 72 to which the virtual WebRTC agent 52 is communicatively coupled. Likewise, the virtual non-WebRTC agent 54 is communicatively coupled to a virtual audio receiver 74, a virtual audio transmitter 76, a virtual video receiver 78, a virtual video transmitter 80, a virtual data receiver 82, and a virtual data transmitter 84 provided by the virtual WebRTC gateway 16.

As the WebRTC interactive flow 18 and the non-WebRTC interactive flow 22 commence, the virtual WebRTC agent 52 and the virtual non-WebRTC agent 54 forward audio signals received from the corresponding WebRTC interactive flow 18 and non-WebRTC interactive flow 22 to the virtual audio receivers 62 and 74. The virtual WebRTC agent 52 and the virtual non-WebRTC agent 54 also forward video signals received from the corresponding WebRTC interactive flow 18 and non-WebRTC interactive flow 22 to the virtual video receivers 66 and 78, and forward data received from the corresponding WebRTC interactive flow 18 and non-WebRTC interactive flow 22 to the virtual data receivers 70 and 82.

The virtual audio receiver 62 that is communicatively coupled to the virtual WebRTC agent 52 is configured to direct audio signals received from the virtual WebRTC agent 52 to the virtual audio transmitter 76 that is communicatively coupled to the virtual non-WebRTC agent 54. The virtual video receiver 66 that is communicatively coupled to the virtual WebRTC agent 52 is configured to direct video signals received from the virtual WebRTC agent 52 to the virtual video transmitter 80 that is communicatively coupled to the virtual non-WebRTC agent 54. The virtual data receiver 70 that is communicatively coupled to the virtual WebRTC agent 52 is configured to direct data received from the virtual WebRTC agent 52 to the virtual data transmitter 84 that is communicatively coupled to the virtual non-WebRTC agent 54.

In a similar fashion, the virtual audio receiver 74 that is communicatively coupled to the virtual non-WebRTC agent 54 is configured to direct audio signals received from the virtual non-WebRTC agent 54 to the virtual audio transmitter 64 that is communicatively coupled to the virtual WebRTC agent 52. The virtual video receiver 78 that is communicatively coupled to the virtual non-WebRTC agent 54 is configured to direct video signals received from the virtual non-WebRTC agent 54 to the virtual video transmitter 68 that is communicatively coupled to the virtual WebRTC agent 52. The virtual data receiver 82 that is communicatively coupled to the virtual non-WebRTC agent 54 is configured to direct data received from the virtual non-WebRTC agent 54 to the virtual data transmitter 72 that is communicatively coupled to the virtual WebRTC agent 52.

It is to be understood that, in some embodiments, one or more of the audio signals, the video signals, and/or the data of the non-WebRTC interactive flow 22 may not be accessible depending on the capabilities and functionality provided by the virtual non-WebRTC agent 54 and/or the non-WebRTC client 34. For instance, some embodiments of the virtual non-WebRTC agent 54 and/or the non-WebRTC client 34 may provide an audio signal and a video signal, but may not be capable of providing a data flow and/or may only provide a data flow using proprietary standards. In such embodiments, the virtual audio receivers 62 and/or 74, the virtual video receivers 66 and/or 78, and/or the virtual data receivers 70 and/or 82 may be omitted.

From the perspective of the WebRTC client 32 and the non-WebRTC client 34, the resulting interactive session including the WebRTC interactive flow 18 and the non-WebRTC interactive flow 22 appears no different from an interactive session transported over a direct peer connection. During the resulting interactive session, the virtual WebRTC gateway 16 may extract content from the WebRTC interactive flow 18 and/or the non-WebRTC interactive flow 22 by accessing an input from the virtual audio receivers 62 and/or 74, the virtual video receivers 66 and/or 78, and/or the virtual data receivers 70 and/or 82. The virtual WebRTC gateway 16 may also inject content into the WebRTC interactive flow 18 and/or the non-WebRTC interactive flow 22 by modifying an output from the virtual audio transmitters 64 and/or 76, the virtual video transmitters 68 and/or 80, and/or the virtual data transmitters 72 and 84. Thus, some embodiments may provide that content may be extracted from or injected into the WebRTC interactive flow 18 and/or the non-WebRTC interactive flow 22. In some embodiments, content from the WebRTC interactive flow 18 and/or the non-WebRTC interactive flow 22 may be recorded or transformed by the virtual WebRTC gateway 16.

In some embodiments, content from the WebRTC interactive flow 18 and/or the non-WebRTC interactive flow 22 may be optionally directed to or received from a functionality provider 86 as indicated by bidirectional video feed 88, bidirectional audio feed 90, and bidirectional data feed 92. The functionality provider 86 may provide additional media processing and handling functionality, such as recording or transforming content of the WebRTC interactive flow 18 and/or the non-WebRTC interactive flow 22. In some embodiments, the functionality provider 86 may provide content, such as audio or video announcements, to be injected into the WebRTC interactive flow 18 and/or the non-WebRTC interactive flow 22.

In the example of FIG. 1, the virtual WebRTC gateway 16 and/or the WebRTC application provider 56 may determine the specific client type and/or client version of the WebRTC client 32 prior to instantiating the virtual WebRTC agent 52. In some embodiments, the client type and/or client version of the WebRTC client 32 may be determined based on data received as part of a WebRTC offer/answer exchange, a query/response exchange between the virtual WebRTC gateway 16 and the WebRTC client 32, or HTTP header data, or other data provided by the WebRTC client 32. The virtual WebRTC gateway 16 may then instantiate the virtual WebRTC agent 52 having a client type and/or version corresponding to the client type and/or version of the WebRTC client 32. Because the WebRTC client 32 directly communicates with a virtual WebRTC agent 52 of the same type and version, incompatibilities due to varying levels of support for WebRTC by the WebRTC client 32 may be resolved.

In some embodiments, a call control application provider 94 may be provided to further facilitate the management of an interactive session between the WebRTC client 32 and the non-WebRTC client 34. As a non-limiting example, the call control application provider 94 may provide a call control application (not shown) that may be downloaded to the WebRTC client 32 via a HTTP/HTTPS connection 96. The call control application provider 94 may provide additional functionality for generating and sending appropriate interactive flow management commands to the virtual non-WebRTC agent 54 via the call control application provider 94. For instance, if the non-WebRTC client 34 is a SIP client, the call control application provider 94 may provide the WebRTC client 32 with a call control application having an HTML5 interface for initiating, terminating, conferencing, and/or transferring a SIP interactive session. The call control application provider 94 may then translate input from the WebRTC client 32 into the corresponding SIP commands, and may relay the corresponding SIP commands to the virtual non-WebRTC agent 54.

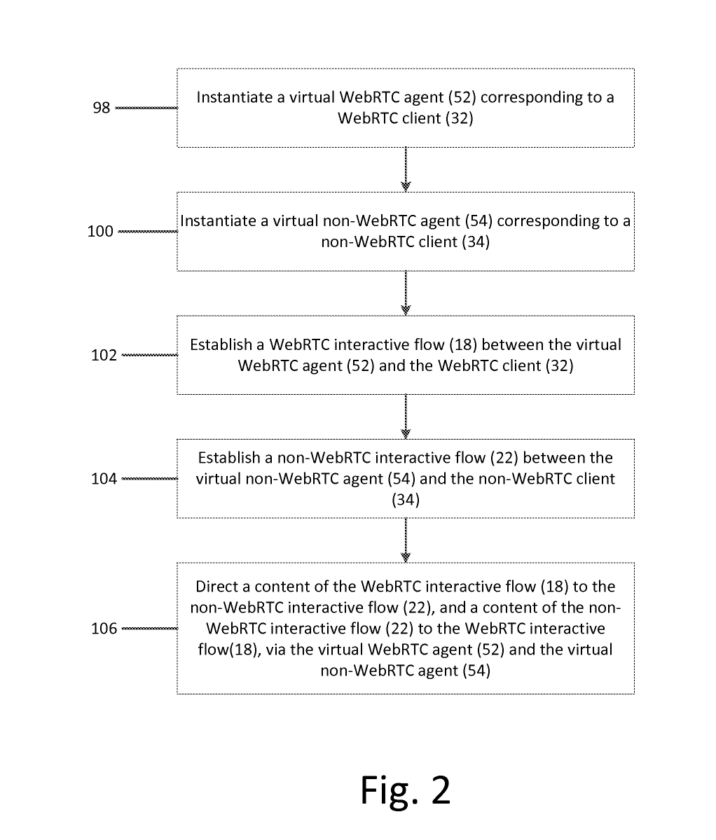

To generally describe exemplary operations of the virtual WebRTC gateway 16 of FIG. 1 for providing the virtual WebRTC agent 52 and the virtual non-WebRTC agent 54, FIG. 2 is provided. For the sake of clarity, elements of FIG. 1 are referenced in describing FIG. 2. In the example of FIG. 2, operations begin with the WebRTC application provider 56 instantiating a virtual WebRTC agent 52 corresponding to a WebRTC client 32 (block 98). As a non-limiting example, the virtual WebRTC gateway 16 may instantiate the virtual WebRTC agent 52 by launching an instance of a WebRTC client, such as a web browser, on the computing device 14. The virtual WebRTC gateway 16 then instantiates a virtual non-WebRTC agent 54 corresponding to a non-WebRTC client 34 (block 100). In some embodiments, the virtual WebRTC gateway 16 may instantiate the virtual non-WebRTC agent 54 by launching an instance of a non-WebRTC client, such as a SIP user agent client, an H.323 client, or a Jingle client, on the computing device 14.

The virtual WebRTC gateway 16 then establishes a WebRTC interactive flow 18 between the virtual WebRTC agent 52 and the WebRTC client 32 (block 102). The virtual WebRTC gateway 16 also establishes a non-WebRTC interactive flow 22 between the virtual non-WebRTC agent 54 and the non-WebRTC client 34 (block 104). The virtual WebRTC gateway 16 next directs a content of the WebRTC interactive flow 18 to the non-WebRTC interactive flow 22, and a content of the non-WebRTC interactive flow 22 to the WebRTC interactive flow 18 via the virtual WebRTC agent 52 and the virtual non-WebRTC agent 54 (block 106). This results in a “back-to-back” connection between the virtual WebRTC agent 52 and the virtual non-WebRTC agent 54. In some embodiments, this may be accomplished through the use of virtual audio receivers 62, 74 and transmitters 64, 76, virtual video receivers 66, 78 and transmitters 68, 80, and virtual data receivers 70, 82 and transmitters 72, 84 provided by the virtual WebRTC gateway 16, as illustrated in FIG. 1.

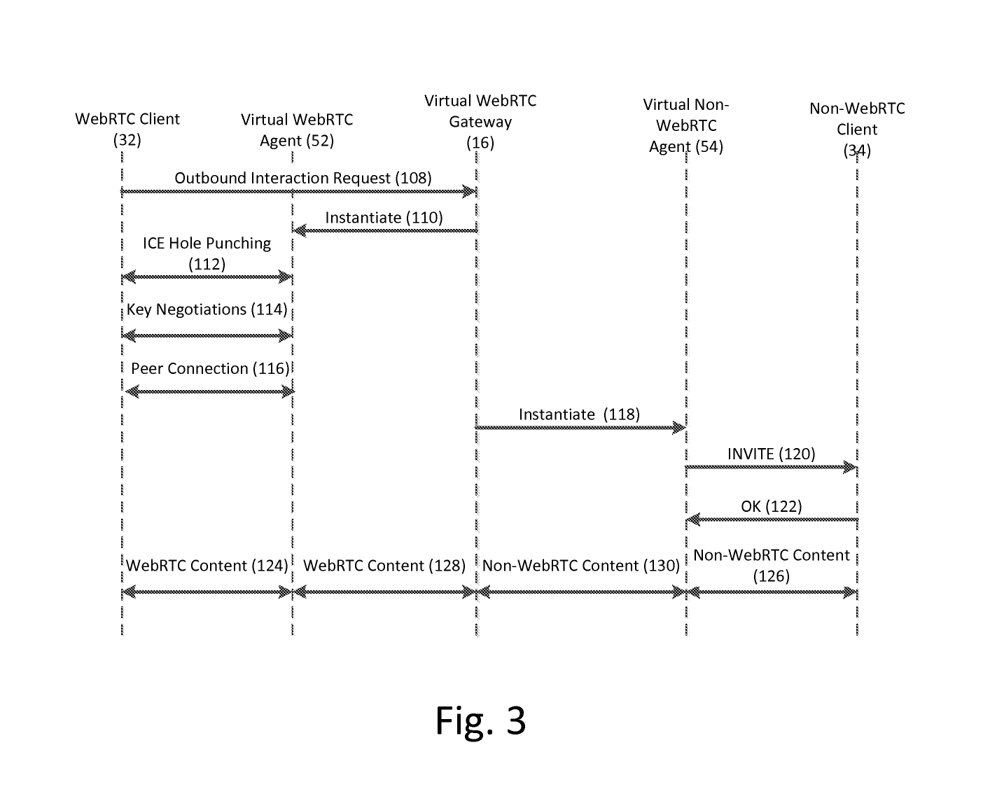

To illustrate exemplary communications flows for an outbound interaction request from a WebRTC client 32 to a non-WebRTC client 34 using the virtual WebRTC agent 52 and the virtual non-WebRTC agent 54 of FIG. 1, FIG. 3 is provided. In FIG. 3, the WebRTC client 32, the virtual WebRTC agent 52, the virtual WebRTC gateway 16, the virtual non-WebRTC agent 54, and the non-WebRTC client 34 of FIG. 1 are each represented by vertical dotted lines. It is to be understood for this example that the WebRTC client 32 has downloaded a WebRTC-enabled web application, such as an HTML5/JavaScript WebRTC application, from the interactive flow server 12. In some embodiments, the non-WebRTC client 34 may be a SIP user agent client, an H.323 client, or a Jingle client, as non-limiting examples.

As seen in FIG. 3, the establishment of an interactive session via the virtual WebRTC agent 52 and the virtual non-WebRTC agent 54 begins with the WebRTC client 32 sending an outbound interaction request, represented by arrow 108, to the virtual WebRTC gateway 16. Some embodiments may provide that the outbound interaction request includes a selection of a non-WebRTC protocol by the WebRTC client 32 from a plurality of non-WebRTC protocols supported by the virtual WebRTC gateway 16. In some embodiments, the outbound interaction request may include a SIP Uniform Resource Identifier (URI) or SIP address for the non-WebRTC client 34. In response to receiving the outbound interaction request, the virtual WebRTC gateway 16 instantiates the virtual WebRTC agent 52 corresponding to the WebRTC client 32, as indicated by arrow 110. The virtual WebRTC agent 52 may be instantiated having a client type and/or a client version that is known to be compatible with the WebRTC client 32, based on a WebRTC offer/answer exchange, a query/response exchange between the virtual WebRTC gateway 16 and the WebRTC client 32, or HTTP header data, or other data provided by the WebRTC client 32.

With continuing reference to FIG. 3, the WebRTC client 32 and the virtual WebRTC agent 52 then begin “hole punching,” indicated by bidirectional arrow 112, to determine the best way to establish direct communications. Hole punching is a technique, often using protocols such as Interactive Connectivity Establishment (ICE), in which the WebRTC client 32 and/or the virtual WebRTC agent 52 establish a connection with an unrestricted third-party server (not shown) that uncovers external and internal address information for use in direct communications. If the ICE hole punching indicated by arrow 112 is successful, the WebRTC client 32 and the virtual WebRTC agent 52 begin key negotiations to establish a secure peer connection, as indicated by bidirectional arrow 114. If the key negotiations are successfully concluded, a peer connection is established between the WebRTC client 32 and the virtual WebRTC agent 52, as indicated by bidirectional arrow 116.

Upon establishing a peer connection between the WebRTC client 32 and the virtual WebRTC agent 52, the virtual WebRTC gateway 16 then instantiates the virtual non-WebRTC agent 54 corresponding to the non-WebRTC client 34, as indicated arrow 118. Some embodiments may provide that the virtual non-WebRTC agent 54 is instantiated to correspond to the selected non-WebRTC protocol indicated by the outbound interaction request. Once instantiated, the virtual non-WebRTC agent 54 sends an INVITE request, represented by arrow 120, to the non-WebRTC client 34. In some embodiments, the INVITE request is a protocol-specific message for requesting the initiation of an interactive session. For example, the INVITE request for a SIP client may be a SIP INVITE request sent to the SIP URI or SIP address initially specified by the WebRTC client 32 in the outbound interaction request. If the non-WebRTC client 34 agrees to the outbound interaction request, the non-WebRTC client 34 responds with an OK message to the virtual non-WebRTC agent 54, as indicated by arrow 122. In embodiments where the non-WebRTC client 34 is a SIP client, the OK message may be a SIP “200 OK” response message.

The WebRTC client 32 and the non-WebRTC client 34 then begin exchanging media and/or data flows. As seen in FIG. 3, content of the WebRTC interactive flow 18 passes from the WebRTC client 32 to the virtual WebRTC agent 52, as indicated by bidirectional arrow 124. Similarly, content of the non-WebRTC interactive flow 22 passes from the non-WebRTC client 34 to the virtual non-WebRTC agent 54, as indicated by bidirectional arrow 126. The virtual WebRTC agent 52 and the virtual non-WebRTC agent 54 then send the content of the WebRTC interactive flow 18 and the non-WebRTC interactive flow 22 through the virtual WebRTC gateway 16, as shown by bidirectional arrows 128 and 130. In this manner, the virtual WebRTC gateway 16 may selectively control, monitor, and/or modify the content of the WebRTC interactive flow 18 and/or the non-WebRTC interactive flow 22 between the WebRTC client 32 and the non-WebRTC client 34.

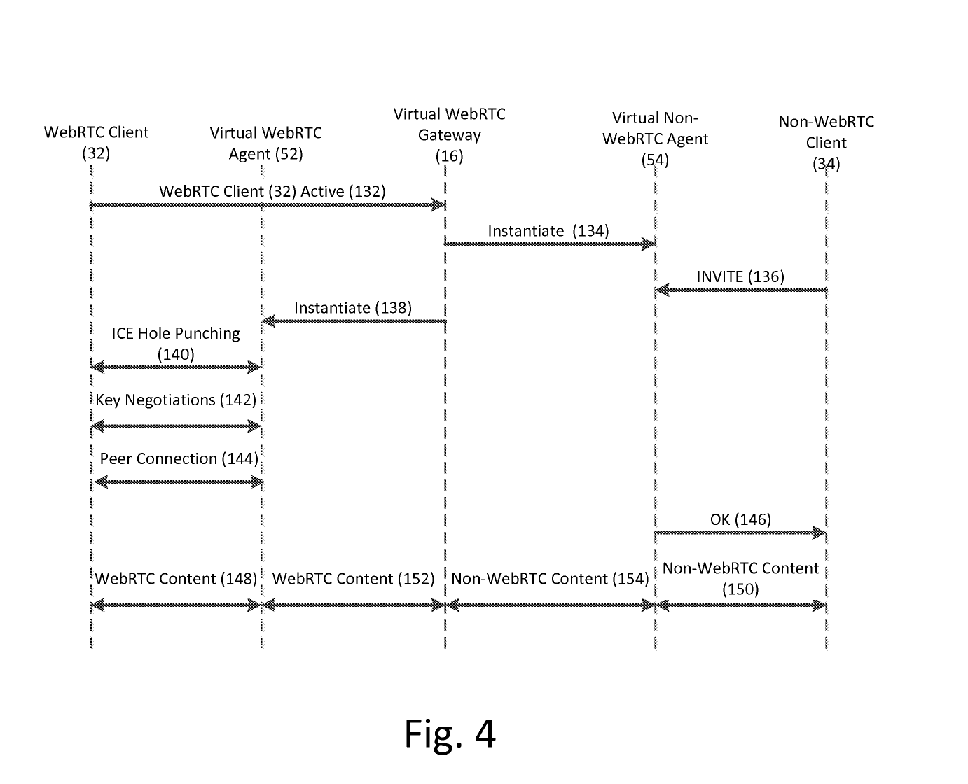

As a complement to the outbound interaction request illustrated in FIG. 3, FIG. 4 illustrates exemplary communications flows for an inbound interaction request to the WebRTC client 32 from the non-WebRTC client 34 using the virtual WebRTC agent 52 and the virtual non-WebRTC agent 54 of FIG. 1. In FIG. 4, the WebRTC client 32, the virtual WebRTC agent 52, the virtual WebRTC gateway 16, the virtual non-WebRTC agent 54, and the non-WebRTC client 34 of FIG. 1 are each represented by vertical dotted lines. It is to be understood for this example that the WebRTC client 32 has downloaded a WebRTC-enabled web application, such as an HTML5/JavaScript WebRTC application, from the interactive flow server 12. In some embodiments, the non-WebRTC client 34 may be a SIP user agent client, an H.323 client, or a Jingle client, as non-limiting examples.

In some embodiments, receiving an inbound interaction request to the WebRTC client 32 from the non-WebRTC client 34 requires that the virtual non-WebRTC agent 54 be instantiated when the WebRTC client 32 is active. Accordingly, in FIG. 4, the virtual WebRTC gateway 16 receives an indication that the WebRTC client 32 is active, as indicated by arrow 132. Upon determining that the WebRTC client 32 is active, the virtual WebRTC gateway 16 instantiates the virtual non-WebRTC agent 54, as indicated by arrow 134. Once instantiated, the virtual non-WebRTC agent 54 awaits an incoming request for interaction.

To initiate an interactive session with the WebRTC client 32, the non-WebRTC client 34 sends an INVITE request, represented by arrow 136, to the virtual non-WebRTC agent 54. In some embodiments, the INVITE request is a protocol-specific message for requesting the initiation of an interactive session. For example, if the non-WebRTC client 34 is a SIP user agent client, the INVITE request may be a SIP INVITE request sent to a SIP URI or SIP address assigned to the WebRTC client 32 and registered with the virtual non-WebRTC agent 54.

In response to receiving the inbound interaction request, the virtual WebRTC gateway 16 instantiates the virtual WebRTC agent 52 corresponding to the WebRTC client 32, as indicated by arrow 138. The virtual WebRTC agent 52 may be instantiated having a client type and/or a client version that is known to be compatible with the WebRTC client 32, based on a WebRTC offer/answer exchange, a query/response exchange between the virtual WebRTC gateway 16 and the WebRTC client 32, or HTTP header data, or other data provided by the WebRTC client 32. The WebRTC client 32 and the virtual WebRTC agent 52 then begin hole punching, as represented by bidirectional arrow 140, to determine the best way to establish direct communications. If the ICE hole punching indicated by arrow 140 is successful, the WebRTC client 32 and the virtual WebRTC agent 52 begin key negotiations to establish a secure peer connection, as indicated by bidirectional arrow 142. Once the key negotiations are successfully concluded, a peer connection is established between the WebRTC client 32 and the virtual WebRTC agent 52, as indicated by bidirectional arrow 144.

Upon establishing a peer connection between the WebRTC client 32 and the virtual WebRTC agent 52, the virtual non-WebRTC agent 54 responds with an OK message to the non-WebRTC client 34, as indicated by arrow 146. In embodiments in which the non-WebRTC client 34 is a SIP client, the OK message may be a SIP “200 OK” response message. The WebRTC client 32 and the non-WebRTC client 34 then begin exchanging media and/or data flows. As seen in FIG. 4, content of the WebRTC interactive flow 18 passes from the WebRTC client 32 to the virtual WebRTC agent 52, as indicated by bidirectional arrow 148. Similarly, content of the non-WebRTC interactive flow 22 passes from the non-WebRTC client 34 to the virtual non-WebRTC agent 54, as indicated by bidirectional arrow 150. The virtual WebRTC agent 52 and the virtual non-WebRTC agent 54 then send the content of the WebRTC interactive flow 18 and the non-WebRTC interactive flow 22 through the virtual WebRTC gateway 16, as shown by bidirectional arrows 152 and 154. In this manner, the virtual WebRTC gateway 16 may selectively control, monitor, and/or modify the content of the WebRTC interactive flow 18 and the non-WebRTC interactive flow 22 between the WebRTC client 32 and the non-WebRTC client 34.

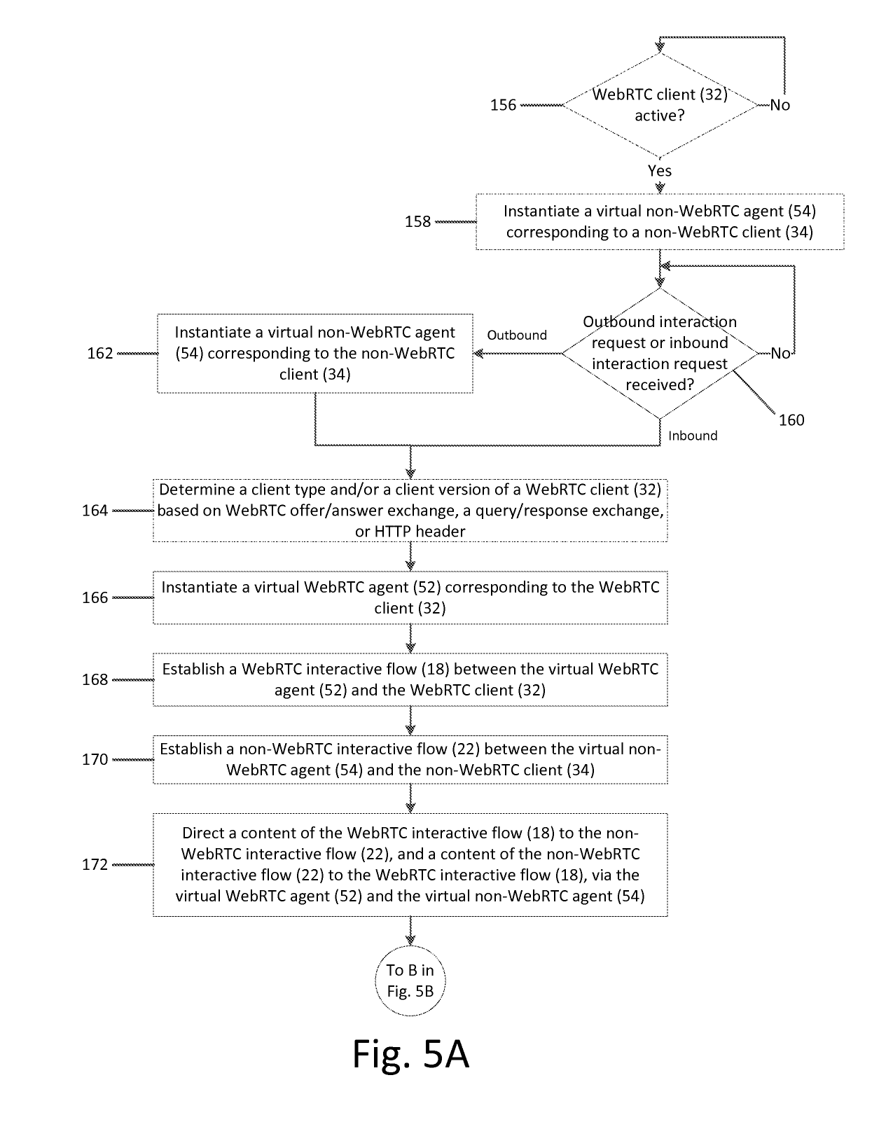

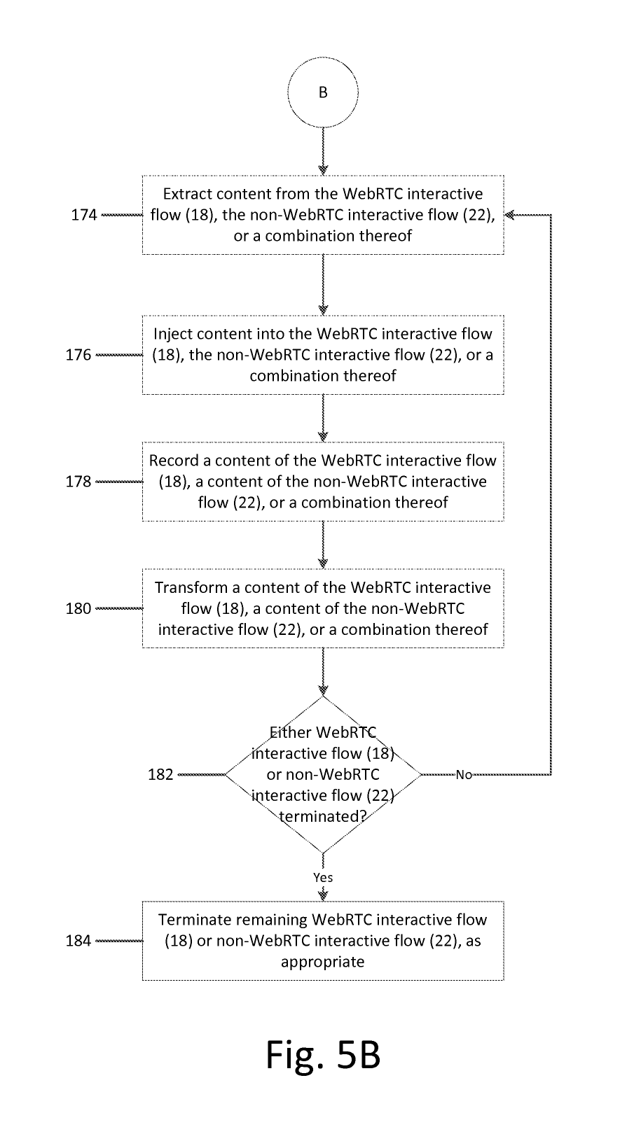

FIGS. 5A and 5B are provided to illustrate in greater detail an exemplary generalized process for the virtual WebRTC gateway 16 of FIG. 1 to provide interoperability between a WebRTC client 32 and a non-WebRTC client 34. For illustrative purposes, FIGS. 5A and 5B refer to elements of the exemplary interactive communications system 10 of FIG. 1. FIG. 5A details operations for establishing an interactive session in response to an inbound interaction request and/or an outbound interaction request. FIG. 5B illustrates operations for providing additional functionality including extracting content from, injecting content into, recording, and/or transforming the content of the WebRTC interactive flow 18 and/or the non-WebRTC interactive flow 22.

In FIG. 5A, processing begins with the virtual WebRTC gateway 16 optionally determining whether the WebRTC client 32 is active (block 156). As noted above with respect to FIG. 4, receiving an inbound interaction request to the WebRTC client 32 from the non-WebRTC client 34 may require that the virtual non-WebRTC agent 54 be instantiated when the WebRTC client 32 is active. Accordingly, if the WebRTC client 32 is determined to be active, the virtual WebRTC gateway 16 may instantiate a virtual non-WebRTC agent 54 corresponding to the non-WebRTC client 34 (block 158). Processing then resumes at block 160. However, if the WebRTC client 32 is determined to not be active at block 156, processing returns to block 156. It is to be understood that some embodiments of the virtual WebRTC gateway 16 may be configured to handle only outbound interaction requests from the WebRTC client 32 to the non-WebRTC client 34. For such embodiments, the functionality of blocks 156 and 158 may be omitted.

The virtual WebRTC gateway 16 then determines whether a request for outbound or inbound interaction has been received (block 160). In some embodiments, an outbound interaction request may include a SIP URI or SIP address for the non-WebRTC client 34. Some embodiments may provide that an inbound interaction request includes a SIP URI or SIP address assigned to the WebRTC client 32. If no outbound or inbound interaction request has been received by the virtual WebRTC gateway 16, processing returns to block 160.

If the virtual WebRTC gateway 16 determines at block 160 that an outbound interaction request has been received from the WebRTC client 32, the virtual WebRTC gateway 16 instantiates a virtual non-WebRTC agent 54 corresponding to the non-WebRTC client 34 (block 162). Processing then resumes at block 164. If the virtual WebRTC gateway 16 determines at block 160 that an inbound interaction request has been received, processing proceeds directly to block 164.

The virtual WebRTC gateway 16 optionally may determine a client type and/or a client version of the WebRTC client 32 based on a WebRTC offer/answer exchange, a query/response exchange between the virtual WebRTC gateway 16 and the WebRTC client 32, or HTTP header data, or other data provided by the WebRTC client 32 (block 164). This may enable the virtual WebRTC gateway 16 to instantiate a virtual WebRTC agent 52 having a client type and/or version corresponding to the client type and/or version of the WebRTC client 32. Because the WebRTC client 32 directly communicates with a virtual WebRTC agent 52 of the same type and version, incompatibilities due to varying levels of support for WebRTC by the WebRTC client 32 may be resolved.

The virtual WebRTC gateway 16 then instantiates a virtual WebRTC agent 52 corresponding to the WebRTC client 32 (block 166). In some embodiments, the virtual WebRTC gateway 16 may instantiate the virtual WebRTC agent 52 by launching an instance of a WebRTC client such as a web browser on the computing device 14. Some embodiments may provide that the virtual WebRTC agent 52 is executed within a virtual instance of an operating system.

The virtual WebRTC gateway 16 then establishes a WebRTC interactive flow 18 between the virtual WebRTC agent 52 and the WebRTC client 32 (block 168). The virtual WebRTC gateway 16 also establishes a non-WebRTC interactive flow 22 between the virtual non-WebRTC agent 54 and the non-WebRTC client 34 (block 170). The virtual WebRTC gateway 16 next directs a content of the WebRTC interactive flow 18 to the non-WebRTC interactive flow 22, and a content of the non-WebRTC interactive flow 22 to the WebRTC interactive flow 18 via the virtual WebRTC agent 52 and the virtual non-WebRTC agent 54 (block 172). This results in a “back-to-back” connection between the virtual WebRTC agent 52 and the virtual non-WebRTC agent 54. In some embodiments, this may be accomplished through the use of virtual audio receivers 62, 74 and transmitters 64, 76, virtual video receivers 66, 78 and transmitters 68, 80, and virtual data receivers 70, 82 and transmitters 72, 84 provided by the virtual WebRTC gateway 16, as illustrated in FIG. 1. Processing then resumes at block 174 of FIG. 5B.

Referring now to FIG. 5B, the virtual WebRTC gateway 16 at this point may access the contents of the WebRTC interactive flow 18 and the non-WebRTC interactive flow 22, and may provide additional media processing and handling functionality. For example, in some embodiments, the virtual WebRTC gateway 16 may extract content from the WebRTC interactive flow 18, the non-WebRTC interactive flow 22, or a combination thereof (block 174). Some embodiments may provide that the virtual WebRTC gateway 16 may inject content into the WebRTC interactive flow 18, the non-WebRTC interactive flow 22, or a combination thereof (block 176). For example, the virtual WebRTC gateway 16 may insert additional audio, video, and/or data into the WebRTC interactive flow 18 and/or the non-WebRTC interactive flow 22. According to some embodiments, the virtual WebRTC gateway 16 may record a content of the WebRTC interactive flow 18, a content of the non-WebRTC interactive flow 22, or a combination thereof (block 178). In some embodiments, the virtual WebRTC gateway 16 may transform a content of the WebRTC interactive flow 18, a content of the non-WebRTC interactive flow 22, or a combination thereof (block 180).

The virtual WebRTC gateway 16 then determines whether either of the WebRTC interactive flow 18 or the non-WebRTC interactive flow 22 has been terminated (block 182). If both the WebRTC interactive flow 18 and the non-WebRTC interactive flow 22 are still active, processing returns to block 174 of FIG. 5B. Otherwise, the virtual WebRTC gateway 16 terminates the remaining active WebRTC interactive flow 18 or non-WebRTC interactive flow 22, as appropriate (block 184).

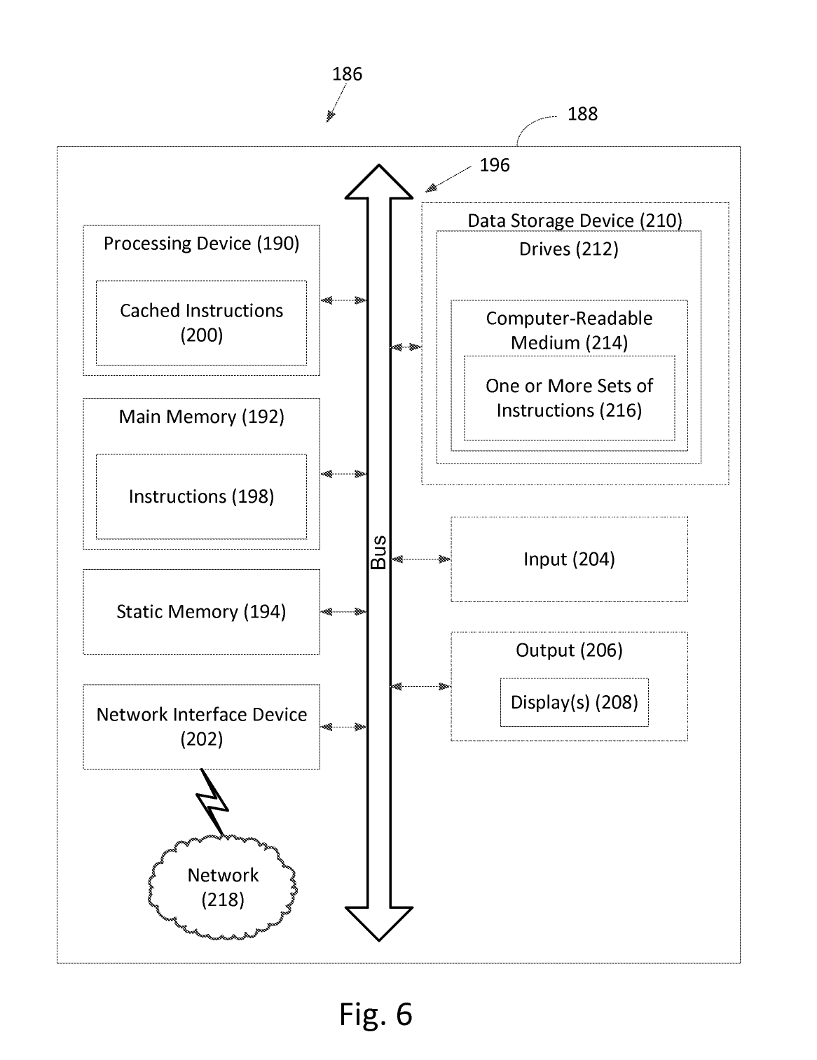

FIG. 6 provides a schematic diagram representation of a processing system 186 in the exemplary form of an exemplary computer system 188 adapted to execute instructions to perform the functions described herein. In some embodiments, the processing system 186 may execute instructions to perform the functions of the WebRTC application provider 56 and the virtual WebRTC gateway 16 of FIG. 1. In this regard, the processing system 186 may comprise the computer system 188, within which a set of instructions for causing the processing system 186 to perform any one or more of the methodologies discussed herein may be executed. The processing system 186 may be connected (as a non-limiting example, networked) to other machines in a local area network (LAN), an intranet, an extranet, or the Internet. The processing system 186 may operate in a client-server network environment, or as a peer machine in a peer-to-peer (or distributed) network environment. While only a single processing system 186 is illustrated, the terms “controller” and “server” shall also be taken to include any collection of machines that individually or jointly execute a set (or multiple sets) of instructions to perform any one or more of the methodologies discussed herein. The processing system 186 may be a server, a personal computer, a desktop computer, a laptop computer, a personal digital assistant (PDA), a computing pad, a mobile device, or any other device and may represent, as non-limiting examples, a server or a user's computer.

The exemplary computer system 188 includes a processing device or processor 190, a main memory 192 (as non-limiting examples, read-only memory (ROM), flash memory, dynamic random access memory (DRAM) such as synchronous DRAM (SDRAM), etc.), and a static memory 194 (as non-limiting examples, flash memory, static random access memory (SRAM), etc.), which may communicate with each other via a bus 196. Alternatively, the processing device 190 may be connected to the main memory 192 and/or the static memory 194 directly or via some other connectivity means.

The processing device 190 represents one or more processing devices, such as a microprocessor, a central processing unit (CPU), or the like. More particularly, the processing device 190 may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The processing device 190 is configured to execute processing logic in instructions 198 and/or cached instructions 200 for performing the operations and steps discussed herein.

The computer system 188 may further include a communications interface in the form of a network interface device 202. It also may or may not include an input 204 to receive input and selections to be communicated to the computer system 188 when executing the instructions 198, 200. It also may or may not include an output 206, including but not limited to display(s) 208. The display(s) 208 may be a video display unit (as non-limiting examples, a liquid crystal display (LCD) or a cathode ray tube (CRT)), an alphanumeric input device (as a non-limiting example, a keyboard), a cursor control device (as a non-limiting example, a mouse), and/or a touch screen device (as a non-limiting example, a tablet input device or screen).

The computer system 188 may or may not include a data storage device 210 that includes using drive(s) 212 to store the functions described herein in a computer-readable medium 214, on which is stored one or more sets of instructions 216 (e.g., software) embodying any one or more of the methodologies or functions described herein. The functions can include the methods and/or other functions of the processing system 186, a participant user device, and/or a licensing server, as non-limiting examples. The one or more sets of instructions 216 may also reside, completely or at least partially, within the main memory 192 and/or within the processing device 190 during execution thereof by the computer system 188. The main memory 192 and the processing device 190 also constitute machine-accessible storage media. The instructions 198, 200, and/or 216 may further be transmitted or received over a network 218 via the network interface device 202. The network 218 may be an intra-network or an inter-network.

While the computer-readable medium 214 is shown in an exemplary embodiment to be a single medium, the term “machine-accessible storage medium” should be taken to include a single medium or multiple media (as non-limiting examples, a centralized or distributed database, and/or associated caches and servers) that store the one or more sets of instructions 216. The term “machine-accessible storage medium” shall also be taken to include any medium that is capable of storing, encoding, or carrying a set of instructions 198, 200, and/or 216 for execution by the machine, and that cause the machine to perform any one or more of the methodologies disclosed herein. The term “machine-accessible storage medium” shall accordingly be taken to include, but not be limited to, solid-state memories, optical and magnetic media, and carrier wave signals.

The embodiments disclosed herein may be embodied in hardware and in instructions that are stored in hardware, and may reside, as non-limiting examples, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. As non-limiting examples, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for providing a virtual Web Real-Time Communications (WebRTC) gateway, comprising:
instantiating, by a virtual WebRTC gateway executing on a computing device, a virtual WebRTC agent corresponding to a WebRTC client;
instantiating a virtual non-WebRTC agent corresponding to a non-WebRTC client;
establishing a WebRTC interactive flow between the virtual WebRTC agent and the WebRTC client;
establishing a non-WebRTC interactive flow between the virtual non-WebRTC agent and the non-WebRTC client; and
directing a content of the WebRTC interactive flow to the non-WebRTC interactive flow, and a content of the non-WebRTC interactive flow to the WebRTC interactive flow, via the virtual WebRTC agent and the virtual non-WebRTC agent.

2. The method of claim 1, wherein the non-WebRTC interactive flow comprises a Session Initiation Protocol (SIP) interactive flow, an H.323 interactive flow, a Jingle interactive flow, or a session-centric interactive flow.

3. The method of claim 1, comprising instantiating the virtual WebRTC agent and instantiating the virtual non-WebRTC agent responsive to receiving an outbound request from the WebRTC client to interact with the non-WebRTC client.

4. The method of claim 3, wherein the outbound request comprises a selection of a non-WebRTC protocol by the WebRTC client from a plurality of non-WebRTC protocols supported by the virtual WebRTC gateway; and
wherein instantiating the virtual non-WebRTC agent comprises instantiating the virtual non-WebRTC agent corresponding to the non-WebRTC protocol.

5. The method of claim 1, comprising:
instantiating the virtual non-WebRTC agent responsive to determining that the WebRTC client is active; and
instantiating the virtual WebRTC agent and establishing the WebRTC interactive flow responsive to receiving, by the virtual non-WebRTC agent, an inbound request from the non-WebRTC client to interact with the WebRTC client.

6. The method of claim 1, further comprising determining a client type or a client version, or a combination thereof, of the WebRTC client based on a WebRTC offer/answer exchange, a query/response exchange between the virtual WebRTC gateway and the WebRTC client, or Hyper Text Transfer Protocol (HTTP) header data, or a combination thereof.

7. The method of claim 1, further comprising recording the content of the WebRTC interactive flow or the content of the non-WebRTC interactive flow, or a combination thereof.

8. The method of claim 1, further comprising transforming the content of the WebRTC interactive flow or the content of the non-WebRTC interactive flow, or a combination thereof.

9. The method of claim 1, further comprising extracting the content from the WebRTC interactive flow or the non-WebRTC interactive flow, or a combination thereof.

10. The method of claim 1, further comprising injecting content into the WebRTC interactive flow or the non-WebRTC interactive flow, or a combination thereof.

11. A system for providing a virtual Web Real-Time Communications (WebRTC) gateway, comprising:
at least one communications interface; and
an interactive flow server associated with the at least one communications interface, the interactive flow server comprising a virtual WebRTC gateway configured to:
instantiate a virtual WebRTC agent corresponding to a WebRTC client;
instantiate a virtual non-WebRTC agent corresponding to a non-WebRTC client;
establish a WebRTC interactive flow between the virtual WebRTC agent and the WebRTC client;
establish a non-WebRTC interactive flow between the virtual non-WebRTC agent and the non-WebRTC client; and
direct a content of the WebRTC interactive flow to the non-WebRTC interactive flow, and a content of the non-WebRTC interactive flow to the WebRTC interactive flow, via the virtual WebRTC agent and the virtual non-WebRTC agent.

12. The system of claim 11, wherein the virtual WebRTC gateway is configured to establish the non-WebRTC interactive flow comprising a Session Initiation Protocol (SIP) interactive flow, an H.323 interactive flow, a Jingle interactive flow, or a session-centric interactive flow.

13. The system of claim 11, wherein the virtual WebRTC gateway is configured to instantiate the virtual WebRTC agent and instantiate the virtual non-WebRTC agent responsive to receiving an outbound request from the WebRTC client to interact with the non-WebRTC client.

14. The system of claim 11, wherein the virtual WebRTC gateway is configured to:
instantiate the virtual non-WebRTC agent responsive to determining that the WebRTC client is active; and
instantiate the virtual WebRTC agent and establish the WebRTC interactive flow responsive to receiving an inbound request from the non-WebRTC client to interact with the WebRTC client.

15. A non-transitory computer-readable medium having stored thereon computer-executable instructions to cause a processor to implement a method, comprising:
instantiating a virtual Web Real-Time Communications (WebRTC) agent corresponding to a WebRTC client;
instantiating a virtual non-WebRTC agent corresponding to a non-WebRTC client;
establishing a WebRTC interactive flow between the virtual WebRTC agent and the WebRTC client;
establishing a non-WebRTC interactive flow between the virtual non-WebRTC agent and the non-WebRTC client; and
directing a content of the WebRTC interactive flow to the non-WebRTC interactive flow, and a content of the non-WebRTC interactive flow to the WebRTC interactive flow, via the virtual WebRTC agent and the virtual non-WebRTC agent.

16. The non-transitory computer-readable medium of claim 15 having stored thereon the computer-executable instructions to cause the processor to implement the method, wherein the non-WebRTC interactive flow comprises a Session Initiation Protocol (SIP) interactive flow, an H.323 interactive flow, a Jingle interactive flow, or a session-centric interactive flow.

17. The non-transitory computer-readable medium of claim 15 having stored thereon the computer-executable instructions to cause the processor to implement the method, comprising instantiating the virtual WebRTC agent and instantiating the virtual non-WebRTC agent responsive to receiving an outbound request from the WebRTC client to interact with the non-WebRTC client.

18. The non-transitory computer-readable medium of claim 15 having stored thereon the computer-executable instructions to cause the processor to implement the method, comprising:
instantiating the virtual non-WebRTC agent responsive to determining that the WebRTC client is active; and
instantiating the virtual WebRTC agent and establishing the WebRTC interactive flow responsive to receiving, by the virtual non-WebRTC agent, an inbound request from the non-WebRTC client to interact with the WebRTC client.

19. The non-transitory computer-readable medium of claim 15 having stored thereon the computer-executable instructions to cause the processor to implement the method, further comprising determining a client type or a client version, or a combination thereof, of the WebRTC client based on a WebRTC offer/answer exchange, a query/response exchange between the virtual WebRTC gateway and the WebRTC client, or Hyper Text Transfer Protocol (HTTP) header data, or a combination thereof.

20. The non-transitory computer-readable medium of claim 15 having stored thereon the computer-executable instructions to cause the processor to implement the method, further comprising recording the content of the WebRTC interactive flow or the content of the non-WebRTC interactive flow, or a combination thereof.
